(19) United States
(12) Patent Application Publication
(10) Pub. No.: US 2026/0355794 A1
(43) Pub. Date: Nov. 12, 2026

(54) METHOD FOR CLEANING A FOOD PRODUCTS MOULD MEMBER

(71) Applicant: MAREL FURTHER PROCESSING B.V., Boxmeer (NL)

(72) Inventors: Albertus DUNNEWIND, Boxmeer (NL); Johannes Martinus MEULENDIJKS, Boxmeer (NL)

(21) Appl. No.: 19/134,837

(22) PCT Filed: Dec. 20, 2023
(86) PCT No.: PCT/EP2023/087085

§ 371 Date: Jun. 2, 2025

(30) Foreign Application Priority Data
Dec. 23, 2022 (NL) 2033819

(51) Int. Cl. B08B 9/08; A22C 7/00

(52) U.S. Cl. CPC B08B 9/0813; A22C 7/0069

(57) ABSTRACT

The present inventio relates to a method for cleaning a food products mould member provided with multiple mould cavities, each with a mould cavity wall formed at least in part by a wall part with a porous structure, the mould member further being provided with an internal fluid passage which extends between a respective feed opening and one or more of the wall parts having porous structures. Use is made of a cleaning device wherein a recirculation circuit is created by placing the mould member in the cleaning device. The method comprising at least one chemical agent based cleaning phase wherein a chemical composition is circulated.

The present invention relates to a method for cleaning a food products mould member. The invention is in particular for the moulding of products from a meat mass, such as for hamburgers and the like, but other edible masses, for example of fish, potato, dough, etc. are also conceivable.

WO00/30458 and WO2004/002229 of the same applicant have disclosed systems having a production device and a mould member provided with at least one mould cavity, the frame supporting the mould member, and furthermore provided with mass feed means for feeding the mass to the one or more mould cavities of the mould member. U.S. Pat. No. 4,975,039, for example, has disclosed a system having a mould member designed as a mould plate which can move to and fro. WO2005/107481 (EP1977648) of the same applicant discloses a system further comprising a mould drum cleaning device disposed at a distance from the production device, as well as rinsing of all the outer side of the drum by the sprayers, followed by rinsing with water via the passages.

WO2020/185067 of the same applicant relates to the cleaning of food product moulding inserts that have been temporarily detached from a movable mould member of a moulding device that is configured for moulding food products from a pumpable foodstuff mass. Use is made of an inserts cleaning device comprising an inserts carrier configured to temporarily mount thereon multiple inserts at respective insert mounting positions, one or more cleaning liquid feed ducts, a pump connected to the one or more cleaning liquid feed ducts, the one or more liquid feed ducts leading from the pump to the mounting positions of the inserts carrier, a collector device for collecting cleaning liquid, and a cleaning liquid recirculation assembly extending from the collector device to the pump, a filter device arranged in the recirculation assembly. The recirculation assembly is provided to recirculate cleaning liquid.

In practice, a food products mould member has to be cleaned every day. In a production cycle, the production device moulds three-dimensional products from a mass of one or more food starting materials which are suitable for consumption, by moving the mould member, e.g. rotating a mould drum or reciprocating a mould plate, and feeding the mass via the cavity opening to the mould cavities with a mass feed device. This process may take two production shifts of 8 hours each. During the production cycle, mass has been fed into the cavities and has possibly entered wall parts with a porous structure. Optionally, during the production cycle, mould cavities are flushed between batches of mass. Flushing is e.g. done using water/air, possibly filtered water/air. After a production cycle, the mould member is cleaned by a cleaning device in a third production shift of 8 hours. This includes possible removal and installation of the mould member from and into a production device, the arrangement and removal of the pressure housings etc. etc.

During cleaning, contaminations such as food material remnants and particles originating from the flushing process, such as filter particles, are to be removed from the mould members, in particular the cavities including the wall part porous structures. In the known cleaning device, as disclosed in WO2005/107481, the cleaning device feeds cleaning fluid to one or more of the passages in the mould member. In this way, a cleaning fluid stream enters via the at least one passage and flows through the wall part porous structure into the mould cavities. Any food material remnant which has stuck to or inside the porous wall part of a mould cavity is forced out and discharged.

A cleaning method commonly includes a rinsing phase and a chemical phase. Such a cleaning method generally consumes a lot of water and energy.

It is an object of the invention to propose an alternative in the area of the cleaning of systems of this type.

This object is achieved by a method according to claim 1, claiming a method for cleaning a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts,
wherein use is made of a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line,
the method comprising at least one chemical agent based cleaning phase wherein a chemical composition, e.g. water mixed with a chemical agent, is circulated, preferably continuous, preferably multiple times, through the recirculation circuit and/or the mould member is sprayed with the chemical composition,
wherein the method comprises, following said at least one chemical agent based cleaning phase, a rinsing phase wherein fresh water which is circulated, preferably continuous, preferably multiple times, through the recirculation circuit, optionally also including spraying of the mould member with fresh water,
characterized in that in the rinsing phase a rinsing cycle is repeatedly performed, which rinsing cycle comprises:
   a filling step wherein a volume of fresh water is filled into the recirculation circuit;
   a recirculation step, wherein the volume of fresh water is recirculated, through the recirculation circuit, so that the water is forced though the internal fluid passage and the associated porous structure wall parts, thereby entraining fouling;
   after completion of the recirculation step, a draining step, in which draining step the recirculated water with entrained fouling is drained from the recirculation circuit.

This object is also achieved by a combination according to claim 15, comprising in combination:
a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts;
a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line;
a control device programmed to carry out the cleaning process of any of the preceding claims.

According to this method and combination for cleaning and cleaning device of the present invention, less water and energy is consumed. In particular, fresh water is not drained immediately, but recirculated prior to draining.

Common masses of food starting materials include e.g. a protein containing mass, e.g. a meat mass, e.g. ground meat mass.

In embodiments, the rinsing cycle is repeated at least three times during the rinsing phase, e.g. at least five time, e.g. more than five times.

In embodiments, a first rinsing cycle of the rinsing phase is carried out with less recirculation of the water than later rinsing cycles.

In embodiments, between the chemical agent based cleaning phase and the rinsing phase a purging step is performed wherein pressurized air is forced through the internal fluid passages and the porous structure wall parts so as to purge the mould member from the liquid chemical composition, e.g. water mixed with a chemical agent, ahead of the rinsing phase, e.g. the purging being done over a predetermined duration, e.g. 30 seconds.

In embodiments, the chemical agent based cleaning phase is performed with heated water mixed with a chemical agent.

In embodiments, during one or more of the rinsing cycles the fresh water is heated fresh water.

In embodiments, the method comprises monitoring the water that is recirculated during the rinsing phase, e.g. wherein conductivity and/or pH are monitored, and/or wherein the presence of fouling is monitored.

In embodiments, the method comprises analysing the water after the water has been drained.

In embodiments, the chemical agent is a cleaning agent, e.g. an alkaline cleaning agent. The chemical agent could also be a disinfecting agent, e.g. an acidic disinfecting agent.

In embodiments, the mould member is dried after the rinsing phase.

In embodiments, the method comprises two chemical agent based cleaning phases, e.g. one involving the use of a cleaning agent and the other involving the use of a disinfecting agent, wherein after each two chemical agent based cleaning phases a rinsing phase is effected, which rinsing phase comprises repeatedly performing a rinsing cycle, which rinsing cycle comprises:
a filling step wherein a volume of fresh water is filled into a recirculation circuit which includes the internal fluid passage and the associated porous structure wall parts of the mould member,
a recirculation step, wherein the volume of fresh water is recirculating through the recirculation circuit so that the water is forced though the internal fluid passage and the associated porous structure wall parts,
after completion of the recirculation step, a draining step, in which draining step the recirculated water is drained from the recirculation circuit.

In embodiments, the method comprises one or more initial rinsing phases prior to the at least one chemical agent based cleaning phase, in which one or more initial rinsing phases fresh water is forced only once though the internal fluid passages and the porous structure wall parts, the water then being drained.

In embodiments, the method comprises a first initial rinsing phase wherein the water filled into the recirculation circuit in each filling step is at a low temperature, e.g. cold, non-heated water, and a second initial rinsing phase wherein the water filled into the recirculation circuit in each filling step is heated, said second initial rinsing phase being followed by one of more chemical agent based cleaning phases.

In embodiments, the porous material is porous sintered metal, e.g. stainless steel.

In embodiments, the mould member is a food products mould drum having an outer drum surface provided with the multiple recessed mould cavities, the mould drum further being provided with internal fluid passages that each extend between a respective feed opening and multiple porous structure wall parts, e.g. of mould cavities arrange in a row.

In embodiments, the mould member has been fouled during production of food products from a meat mass, e.g. ground meat.

The object of the invention is according to a second aspect achieved by a method for cleaning a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts,
wherein use is made of a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line,
the method comprising at least one chemical agent based cleaning phase wherein a chemical composition, e.g. water mixed with a chemical agent, is circulated, preferably continuous, preferably multiple times, through the recirculation circuit,
wherein the method comprises at least one initial rinsing phase prior to the at least one chemical agent based cleaning phase, in which initial rinsing phase fresh water is forced only once though the internal fluid passage and the associated porous structure wall parts, the water then being drained,
characterized in that
in the initial rinsing phase a rinsing cycle is repeatedly performed, which rinsing cycle comprises:
   a filling step wherein a volume of fresh water is filled into the recirculation circuit;
   a soaking step, wherein the water is kept in place in the recirculation circuit so that the internal fluid passage and the associated porous structure wall parts as well as any fouling therein is soaked,
   a purging step that ends the soaking step, in which purging step pressurized air is supplied to the recirculation circuit so that the water is purged from the internal fluid passage and the associated porous structure wall parts, the water being drained, thereby entraining and discharging fouling from the internal fluid passage and the porous structure wall parts.

In embodiments, the duration of at least one soaking step, e.g. of all soaking steps, is at least 30 seconds, e.g. at least 60 seconds, e.g. at least 90 seconds, e.g. between 60 seconds and 180 seconds.

In embodiments, the rinsing cycle is repeated at least three times during an initial rinsing phase, e.g. at least four times.

In embodiments, the duration of the purging step is at least 3 seconds, e.g. between 3 and 10 seconds, e.g. about 5 seconds.

In embodiments, the duration of the filling step is at most 10 seconds, e.g. between 4 and 10 seconds, e.g. about 5 seconds In embodiments, during the purging step the air pressure at the feed opening of the internal fluid passage is at least 5 bars, e.g. between 5 and 15 bars, e.g. between 6 and 10 bars.

In embodiments, the method comprises a first initial rinsing phase wherein the water filled into the recirculation circuit in each filling step is at a low temperature, e.g. cold, non-heated water, and a second initial rinsing phase wherein the water filled into the recirculation circuit in each filling step is heated, said second initial rinsing phase being followed by one of more chemical agent based cleaning phases.

In embodiments, the method comprise a chemical agent removal rinsing phase that follows the chemical agent based cleaning phase, in which chemical agent removal rinsing phase fresh water is forced only once though the internal fluid passage and the associated porous structure wall parts, the water then being drained.

In embodiments, the method comprises two chemical agent based cleaning phases, e.g. one involving the use of a cleaning composition, e.g. an alkaline cleaning composition, and the other involving the use of a disinfecting composition, e.g. an acidic disinfecting composition, e.g. the acidic disinfecting composition causing at least a descaling of the mould member, wherein after each of the two chemical agent based cleaning phases a chemical agent removal rinsing phase is carried out, in which chemical agent removal rinsing phase fresh water is forced only once though the internal fluid passage and the associated porous structure wall parts, the water then being drained.

In embodiments, the chemical agent removal rinsing phase a chemical agent removal rinsing cycle is repeatedly performed, which chemical agent removal rinsing cycle comprises:
a filling step wherein a volume of fresh water is filled into a recirculation circuit that includes the internal fluid passage and the associated porous structure wall parts of the mould member such that the water is present in the internal fluid passage and the associated porous structure wall parts of the mould member,
a purging step directly following the filling step, in which purging step pressurized air is supplied to the recirculation circuit so that the water is purged from the internal fluid passage and the associated porous structure wall parts, the water being drained, thereby entraining and discharging fouling from the internal fluid passage and the porous structure wall parts.

In embodiments, the chemical agent removal rinsing cycle is repeated at least three times.

In embodiments, a real-time analysis is performed of the water that is drained in the chemical agent removal rinsing cycle so as to ascertain that the presence of chemical agent in the drained water, and wherein the rinsing cycle is repeated until presence of chemical agent in the drained water is below a predetermined threshold, the chemical agent removal rinsing phase then being terminated.

In embodiments, the porous material is porous sintered metal, e.g. stainless steel.

In embodiments, the mould member is a food products mould drum having an outer drum surface provided with the multiple recessed mould cavities, the mould drum further being provided with internal fluid passages that each extend between a respective feed opening and multiple porous structure wall parts, e.g. of mould cavities arrange in a row.

In embodiments, the mould member has been fouled during production of food products from a meat mass, e.g. ground meat.

The object of the invention is also achieved according to a second aspect of the invention by a combination of:
a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts;
a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line;
a control device programmed to carry out the cleaning process of the second aspect of the invention.

The object of the invention is according to a third aspect of the invention achieved by a method for cleaning a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts,
wherein use is made of a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line,
the method comprising at least one chemical agent based cleaning phase wherein a chemical composition, e.g. water mixed with a chemical agent, is circulated, preferably continuous, multiple times through the recirculation circuit during a duration of said chemical agent based cleaning phase,
characterized in that
during the at least one chemical agent based cleaning phase the recirculation of the chemical composition is interrupted multiple times, wherein during each interruption a purging step is performed, in which purging step pressurized air is supplied to the feed opening of the internal fluid passage so that the water is purged from the internal fluid passage and the associated porous structure wall parts, thereby entraining and discharging fouling from the internal fluid passage and the porous structure wall parts.

In embodiments, the supply of pressurized air in the purging step follows immediately after the interruption of the recirculation.

In embodiments, an air injection port is provided in the feed line downstream of the pump via which air is injected into the feed line during an interruption of the recirculation of the chemical composition, and wherein between the pump and the air injection port a valve is present, which valve is closed when air is injected into the feed line.

In embodiments, the duration of the purging step is at least 3 seconds, e.g. between 3 and 10 seconds, e.g. about 5 seconds.

In embodiments, during the purging step the air pressure at the feed opening of the internal fluid passage is at least 5 bars, e.g. between 5 and 15 bars, e.g. between 6 and 10 bars.

In embodiments, the method comprises at least one initial rinsing phase prior to the at least one chemical agent based cleaning phase, in which initial rinsing phase fresh water is forced only once though the internal fluid passages and the porous structure wall parts, the water then being drained.

The object of the invention is also achieved according to a third aspect of the invention by a combination of:
a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts;
a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line;
a control device programmed to carry out the cleaning process of the third aspect of the invention.

The object of the invention is according to a fourth aspect of the invention achieved by a method for cleaning a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts,
wherein use is made of a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line,
the method comprising at least one chemical agent based cleaning phase wherein a chemical composition is made in a tank wherein a chemical agent is added to water, which chemical composition is heated by a heater in the tank, which heated liquid chemical composition is pumped by a pump from the tank and forced by the pump though the internal fluid passage and the associated porous structure wall parts, said at least one chemical agent based cleaning phase comprising the recirculation through the recirculation circuit, of the heated chemical composition multiple times during the cleaning phase at a pre-set temperature,
characterized in that
the pump is started before the chemical composition has reached the pre-set temperature, so that a first flow of liquid chemical composition though the internal fluid passage and the associated porous structure wall parts is at a lower temperature than the pre-set temperature.

The object of the invention is also achieved according to a fourth aspect of the invention by a combination of:
a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts;
a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line;
a control device programmed to carry out the cleaning process of the fourth aspect of the invention.

The object of the invention is according to a fifth aspect of the invention achieved by a method for cleaning a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts,
wherein use is made of a cleaning device comprising a pump between a return line and a feed line, a collector connected to the return line, and wherein a recirculation circuit is created placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line,
the method comprising at least one chemical agent based cleaning phase wherein a chemical composition is made in a tank wherein a chemical agent is added to water, which chemical composition is heated by a heater in the tank, which heated liquid chemical composition is pumped by a pump from the tank and forced by the pump though the internal fluid passage and the associated porous structure wall parts, said at least one chemical agent based cleaning phase comprising the recirculation through the recirculation circuit, of the heated chemical composition multiple times during the chemical agent based cleaning phase,
characterized in that
in the at least one chemical agent based cleaning phase, prior to starting the recirculation, a mixing step of the chemical agent with the water is effected, in which mixing step use is made of the pump and an associated tank backflow circuit, wherein the pump recirculates the chemical composition via associated tank backflow circuit directly to the tank, and wherein once mixing is completed recirculation is started.

In embodiments, the tank has a heater, and wherein the mixing step include heating the chemical composition, e.g. to a pre-set temperature.

The object of the invention is also achieved according to a fifth aspect of the invention by a combination of:
a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts;
a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line;
a control device programmed to carry out the cleaning process of the fifth aspect of the invention.

The object of the invention is according to a sixth aspect of the invention achieved by a method for cleaning a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts,
wherein use is made of a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line,
the method comprising at least one chemical agent based cleaning phase wherein a chemical composition, e.g. water mixed with a chemical agent, is circulated, preferably continuous, preferably multiple times, through the recirculation circuit,
wherein the method comprises a chemical agent removal rinsing phase that follows the chemical agent based cleaning phase, in which chemical agent removal rinsing phase fresh water is forced only once though the internal fluid passage and the associated porous structure wall parts, the water then being drained,
wherein the method comprises a drying phase following the chemical agent removal rinsing phase, wherein pressurized air is supplied to the feed opening of the internal fluid passage so that the internal fluid passage and the associated porous structure wall parts are dried,
characterized in that
in the drying phase the pressurized air is supplied alternating at a relatively high pressure and at a relatively low pressure, e.g. wherein the supply at the relatively high pressure is during a relatively short period and predominantly to purge water from the internal fluid passage and the associated porous structure wall parts and wherein the supply at the relatively low pressure is during a relatively long period to effect a drying of the internal fluid passage and the associated porous structure wall parts.

The object of the invention is also achieved according to a sixth aspect of the invention by a combination of:
a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts;
a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line;
a control device programmed to carry out the cleaning process of the sixth aspect of the invention.

The object of the invention is according to a seventh aspect of the invention achieved by a method for cleaning a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts,
wherein use is made of a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line,
the method comprising at least one chemical agent based cleaning phase wherein a chemical composition, e.g. water mixed with a chemical agent, is circulated, preferably continuous, multiple times, through the recirculation circuit,
characterized in that
the pump is configured and operated to generate a pulsating flow of liquid chemical composition that is supplied to the feed opening, said pulsating flow having a continuous component and a fluctuating component, e.g. the fluctuating component having a frequency of at most 10 Hz, preferably between 1 and 3 Hz.

In embodiments, a pump provides a continuous flow of liquid chemical composition and wherein a pulsator generates the fluctuating component.

The object of the invention is also achieved according to a seventh aspect of the invention by combination of:
a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts;
a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line;
a control device programmed to carry out the cleaning process of the seventh aspect of the invention.

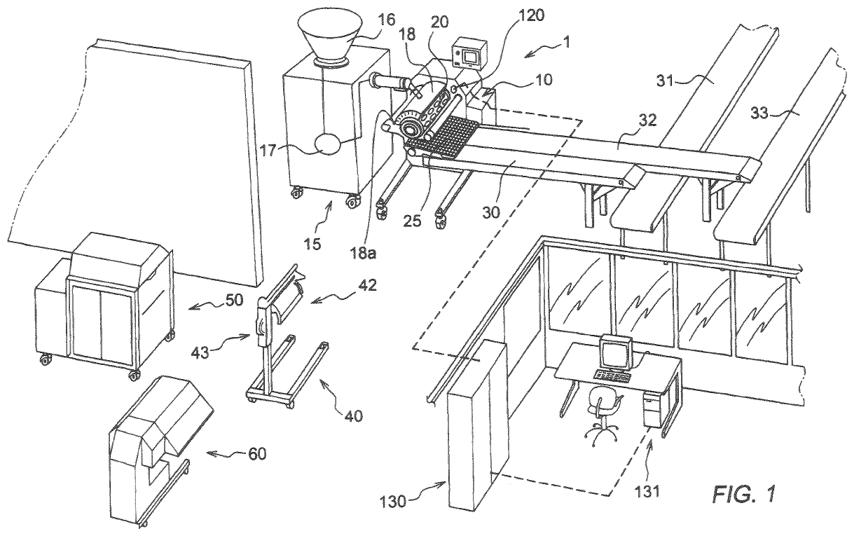

FIG. 1 diagrammatically depicts an exemplary embodiment of a system according to the invention having a production device, mould drum cleaning device, cleaning device for the production device,

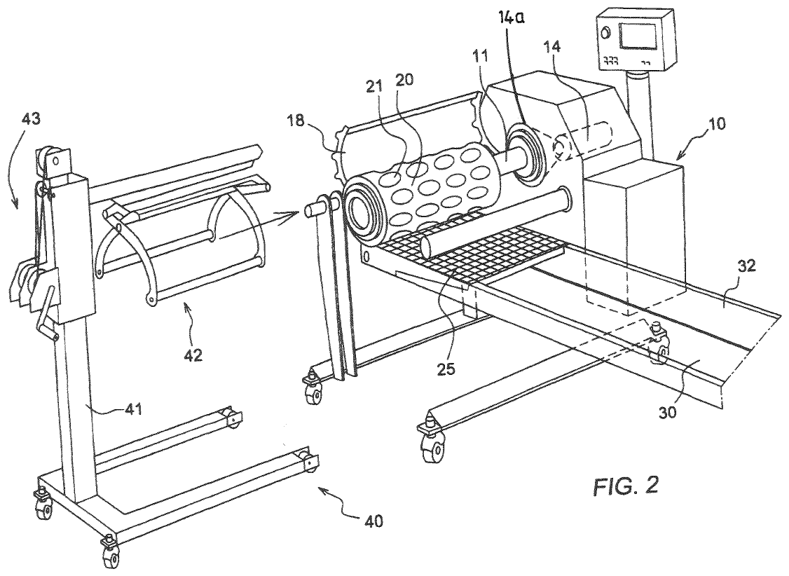

FIG. 2 diagrammatically depicts a part of the production device with mould drum, and conveyor means for the mould drum from FIG. 1,

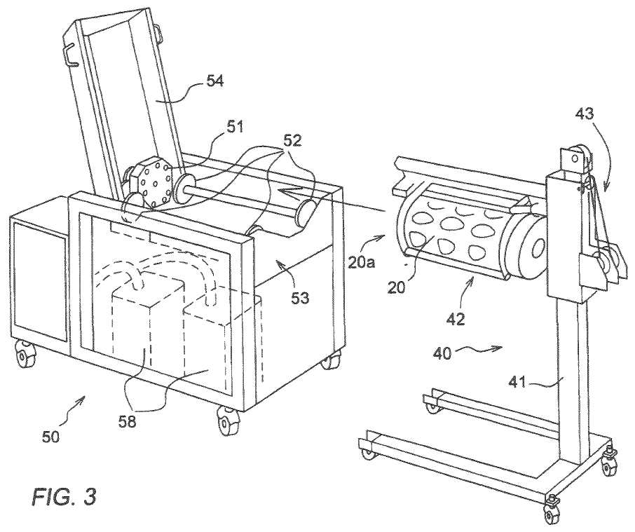

FIG. 3 diagrammatically depicts the positioning of the mould drum in the mould drum cleaning device from FIG. 1,

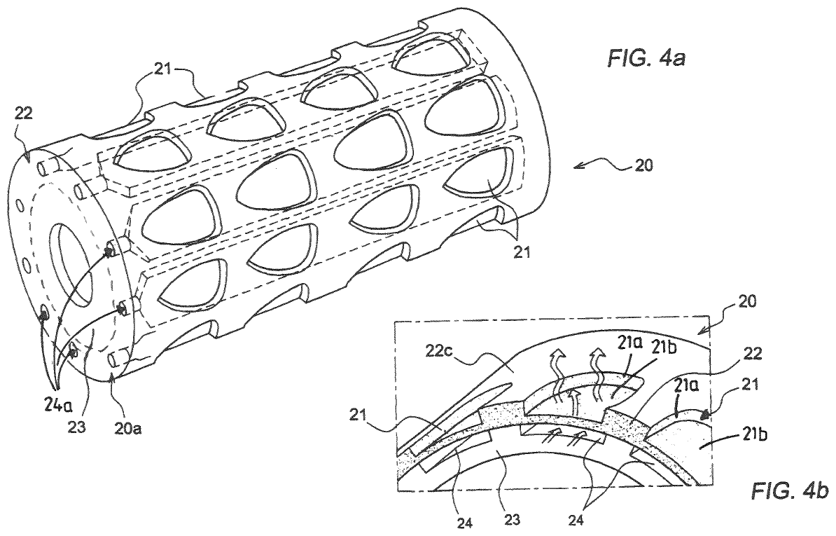

FIG. 4a shows a mould drum according to the invention,

FIG. 4b shows a cross section through part of the mould drum from FIG. 4a,

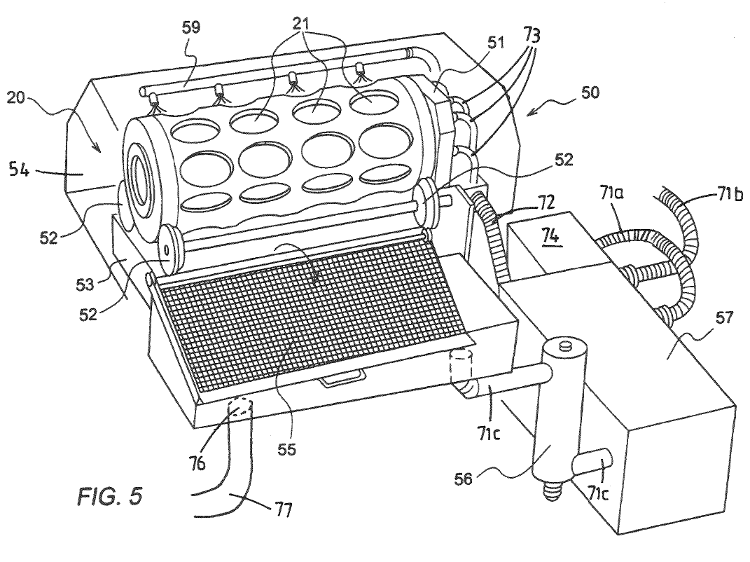

FIG. 5 diagrammatically depicts part of the mould drum cleaning device from FIG. 3,

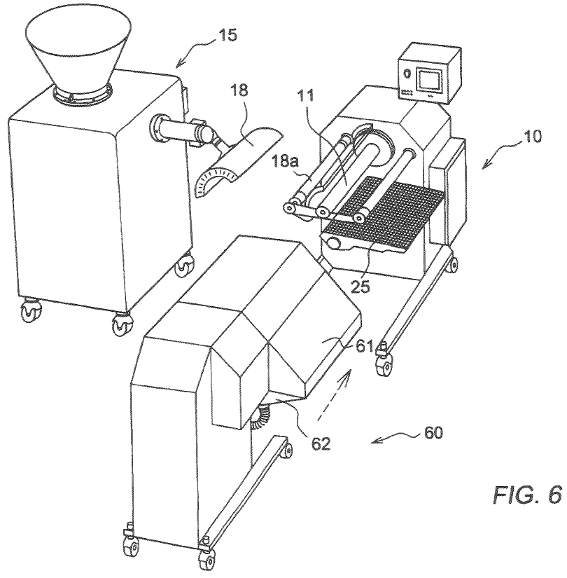

FIG. 6 diagrammatically depicts the production device and an associated cleaning device from FIG. 1,

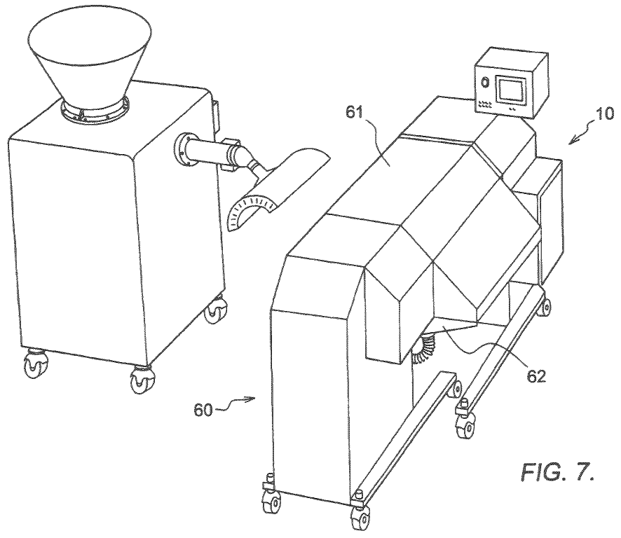

FIG. 7 shows the production device and the cleaning device which has been positioned against part of it.

In the figures, reference numeral 1 denotes a production device which is designed to mould three-dimensional products from a mass of one or more food starting materials which are suitable for consumption, in particular human consumption, in particular a meat-containing mass.

The production device 1 is described in detail in WO 2004/002229, the contents of which are hereby deemed to be incorporated in the present application.

The production device 1 has a mould drum 20, as will be explained in more detail below. The production device 1 is only an example aimed at explaining the invention. The invention can also be realized using production devices of different designs, for example as shown in WO 00/30458.

By way of example, the invention can be used on production devices in which the mould member comprises a mould plate which is movable, for example can slide to and fro, which mould plate is provided with one or more mould cavities, which mould cavities each have an opening in at least one plate surface, the mass feed means comprising one or more mass feed members arranged along a plate surface. A production device of this type is often also used for the moulding of meat products, such as for example hamburgers. A device of this type is shown, for example, in U.S. Pat. No. 4,975,039.

The production device 1 has a mould drum part 10 with a frame, in this case a frame which can be moved over the floor and supports a mould member designed as a mould drum 20. The mould drum 20 has a drum surface at the outer circumference which is provided with a plurality of mould cavities 21.

The frame 10 is provided with a horizontal mould drum fitting spindle 11, so that the mould drum 20 is rotatable with respect to the frame 10 about the spindle 11.

In an embodiment which is not shown, the frame may have a plurality of mould drum fitting spindles, or the frame comprises other support means for supporting the mould drum rotatably with respect to the frame.

At one end, the fitting spindle 11 is fixed to the frame 10, so that the mould drum 20 can be pushed onto the fitting spindle 11 and removed from the free end.

Furthermore, the frame 10 is provided with mould drum drive means 14 for rotating the mould drum 20. In the embodiment shown, a statically disposed distributor 14a, suitable for supplying or sucking out a liquid or gaseous forcing agent, such as air, compressed air, water or steam or the like, is arranged in the vicinity of the mould drum drive means 14. A distributor which is known per se is provided with a pump and slots through which the forcing agent can flow. On account of the distributor 14a being disposed in a static position, the rotating mould drum alternately moves past forcing agent feed slots and forcing agent discharge slots.

Furthermore, the production device 1 has a mass feed part 15, which is likewise designed such that it can be moved over the floor and is provided with a storage container 16 for mass, in this example a (kneaded) meat mass, pump means 17 (illustrated highly diagrammatically) for pumping the mass, and a mass feed member 18 connected to the pump means 17. At a mass feed position, the mass feed member 18 bears against the outer circumference of the mould drum 20, so that (meat) mass can be fed to the passing mould cavities 21 of the rotating mould drum 20 under a filling pressure.

In this example, the mass feed member 18 is supported pivotably by means of a support spindle 18a on the frame 10.

Here, the frame 10 is also provided with a discharge member 25 for discharging the moulded products, in this case in the form of a (mesh) belt conveyor 25 which extends as far as beneath the mould drum 2, so that products which have been ejected from the mould cavities 21 in the region of the underside of the belt pass onto the said belt conveyor 25.

The system comprises further product conveyor means, in this case two sets of belt conveyors 30, 31 and 32, 33, for discharging moulded products, if appropriate to further product treatment devices.

As has been stated, the mould drum 20 is removable. For this purpose, in FIGS. 1-3 a mould drum conveyor 40 is provided. This conveyor 40, shown by way of example, has a movable frame 41, a mould drum gripper 42 and lifting means 43 for moving the gripper 42 up and down.

It can be seen from FIG. 2 that after the mass feed member 18 has been moved away from the mould drum 20, the conveyor 40 can be moved towards the frame 10, so that the gripper 42 can handle the mould drum 20. Then, the gripper 42 is moved to the correct height, so that it bears the weight of the mould drum 20 and the mould drum 20 is slid off the spindle 11.

Then, the mould drum 20 can be displaced to a mould drum cleaning device 50, which is disposed at a distance from the production device 1. It should be noted that there is no need to provide a fixed arrangement, but rather, as can be seen, the device 50 is likewise of movable design. However, it is preferable for the cleaning work to be carried out at a different location from the production of foodstuffs.

The design of the cleaning device 50 and the cleaning of the mould drum 20 will now be explained in more detail with reference to FIGS. 3-5; in this context, it should be noted that this is an example of the invention.

As is diagrammatically depicted in FIG. 3 by the arrow, the mould drum 20 is placed in the cleaning device 50 with the aid of conveyor 40. The cleaning device 50 is in this case designed to carry out a plurality of possible cleaning processes substantially automatically, in particular the inventive cleaning processes as claimed.

It can be seen from FIG. 4a,b that the mould drum 20 is provided with mould cavities 21 each having a mould cavity wall, which is formed at least in part by a wall part with a porous structure.

In the preferred embodiment of the mould drum 20 shown, there is an outer drum 22, which is made at least in part (and in this example completely) from material with a porous structure, in such a manner that a mould cavity 21 has a mould cavity wall 21a, 21b, which is at least partially porous. At the head ends of the drum the porous structure is closed, e.g. by sealing.

Inside the outer drum 22 there is positioned an inner member 23 which fits into the outer drum 22, the inner member 23, together with the adjoining surface of the outer drum 22, forming a number of passages 24 which extend from one head end 20a of the mould drum 20, optionally to the opposed head end of the drum, so that a medium can be forced through the porous walls of the mould cavities 21 and/or suction can take place via a passage 24 of this type. The said medium, for example compressed air, can be used, for example, to release the moulded product from a mould cavity 21. The suction can be used to extract air during the filling operation and/or, for example, to suck a film or the like into the mould cavity.

In a variant which is not shown, the passages 24, if appropriate branching into passages of smaller diameter, continue as far as the mould cavity, in which case the porous wall, for example made from sintered metal, is then absent.

It can be seen from FIG. 4b that in the shown embodiment the outer surface of the inner member 23 is provided with grooves which extend substantially in the axial direction and form the passages 24.

The outer drum 22 could, for example, be assembled from one or more rings of porous material, for example porous metal, in which case the one or more mould cavities 21 are formed by a material-removing machining operation, for example an electro-erosive machining operation.

If appropriate, the mould drum may comprise rings, optionally provided with mould cavities, which are releasably coupled to one another, so that a set of rings is obtained as seen in the axial direction of the mould drum. This can serve to influence the capacity of the moulding device, for example by combining rings with and without mould cavities and/or rings with different numbers and/or shapes of the mould cavities. It should be noted that when the mould member is designed as a mould plate, it is also possible to make use of an assembly of parts which forms the final mould plate.

If the outer drum 22 is made from metal, the porous structure can be sealed in the outermost part 22c of the surface of the outer drum by a lubricating action during the machining of the metal porous drum 20 in a lathe. Obviously, the sealing of the said outermost part 22c could also be realized in other ways, for example by the application of a coating layer (which if appropriate partially penetrates into the porous material).

In an embodiment which is not shown, the mould drum only comprises an “outer” wall, for example such as the component 22 shown in FIG. 4b. The frame may then, for example, comprise passages via which a medium (air) can be displaced to or from the mould cavities in the mould drum. By way of example, it is possible to provide for the fitting spindle to be provided with passages, such as for example the passages 24. In a variant, the frame comprises the inner member 23 (optionally releasable), and the mould drum is formed by component 22, which can be removed from the inner member 23. As will subsequently be demonstrated, it would then be possible, for example, for only the “outer drum” 22 to be placed in the cleaning device 50, and for a storage device for outer drums 22 to be provided.

It would also be possible to provide for the mould drum to be supported by supporting features at both head-ends of the mould drum.

The cleaning device 50 is designed to carry out any of the cleaning methods described in this document. The cleaning device is able to force at least one cleaning liquid through the wall parts with the porous structure into the mould cavities 21. As can be seen in FIG. 4a, the passages 24 leading to each mould cavity 21 each have a feed opening 24a in an end face 20a of the mould drum 20.

In the shown embodiment, the cleaning device 50 has a distributor 51 which comes to bear against the head-end face 20a, for the purpose of feeding cleaning liquid to one or more of the passages 24. In this way, any possible contamination which has stuck to or in the porous wall part of a mould cavity 21 is forced out and discharged.

The cleaning device 50 is provided with supporting means 52 for rotatably supporting the mould drum 20 that is to be cleaned, in this case rollers 52 which bear against the outer circumference of the drum and, via a motor (not shown), serve as drive means for driving the mould drum 20 to be cleaned in rotation. In an embodiment which is not shown, the mould drum to be cleaned can be driven by a central shaft.

The shown cleaning device 50 has a collector, here trough 53 for collecting cleaning liquid and a cover 54, so that the cleaning of the mould drum 20 can take place in a closed chamber.

Here, the collector is provided with a drain 76 to allow drainage of cleaning liquid through a drainage line 77.

It is also conceivable that the cleaning device comprises a housing, such as a pressure housing as disclosed in WO2017155390, forming a chamber wherein cleaning liquid is collected.

The cleaning device 50 comprises a pump 57 between a return line 71c and a feed line 72, the collector being connected to the return line 71c.

Here, the feed line 72 branches into multiple passage feed lines 73, each passage feed line 73 providing pressurized fluid via distributor 51 an feed openings 24a to the fluid passages 24.

A recirculation circuit is created by placing the mould member 20 in the cleaning device 50 and connecting the feed line 72 to the feed opening 24a, so that the recirculation circuit comprises the pump 57, feed line 72, internal fluid passage 24 of the mould member, wall parts 22 of the mould member having porous structures, mould cavities 21, the collector 53 and the return line 71c.

In embodiments, the return line 71c is provided with a filter for filtering the cleaning liquid, for example a coarse filter 55 and a fine filter 56.

To carry out a chemical agent based cleaning phase, a chemical composition, e.g. stored in container 74, e.g. a liquid composition, e.g. water mixed with a chemical agent, is provided via line 71a to the recirculation circuit to be circulated, preferably continuous, preferably multiple times, through the recirculation circuit and/or the mould member is sprayed with the chemical composition.

In a possible method, following said at least one chemical agent based cleaning phase, a rinsing phase takes place.

To carry out a rinsing phase, fresh water which is provided via line 71b to the recirculation circuit to be circulated, preferably continuous, preferably multiple times, through the recirculation circuit, optionally also including spraying of the mould member with fresh water.

In embodiments, in the rinsing phase a rinsing cycle is repeatedly performed, which rinsing cycle comprises:
a filling step wherein a volume of fresh water is filled into the recirculation circuit, e.g. via line 71b;
a recirculation step, wherein the volume of fresh water is recirculated, through the recirculation circuit, so that the water is forced though the internal fluid passage 24 and the associated porous structure wall parts 22, thereby entraining fouling;
after completion of the recirculation step, a draining step, in which draining step the recirculated water with entrained fouling is drained from the recirculation circuit, here via drainage line 77.

It is preferable to provide heating means for heating the cleaning liquid. Furthermore, there are means for mixing one or more chemicals with a cleaning liquid, for example a disinfectant, stored, for example, in containers.

In the shown embodiment, the cleaning device 50 comprises spraying means 59 are provided for cleaning the mould member, e.g. in a chemical agent based cleaning phase and/or in a rinsing phase.

In one possible cleaning process, first of all the outer side of the drum is rinsed/coarse cleaned by the sprayers 59, followed by rinsing with cold water (together with a suitable cleaning agent) via the passages 24, followed by disinfection with water provided with suitable chemicals and a final rinse via the passages and on the outside with cold water. As an alternative, one or more steps could also be carried out using hot water (40-90 degrees Celsius).

In embodiments, the a control device 130 is provided, here having an associated computer 131, programmed to carry out a cleaning process described in this document.

The cleaning could also comprise descaling of the mould member, for example using a suitable acid, which may be of relevance in particular to mould cavities with a porous wall structure.

In an embodiment which is not shown, the cleaning device comprises inspection means. These inspection means, for example having a digital (infrared) camera with associated image-processing means, can monitor the cleaning and also the state of the mould drum. By way of example, it is possible to detect damage and/or wear to the drum. These inspection results can be stored in a memory and if appropriate interpreted in combination with the use/cleaning history, for example in order to determine the expected service life.

Furthermore, the system comprises a second cleaning device 60, which is designed to clean that part of the production device 1 which bears the mould drum 20, in particular after the said mould drum 20 has been removed. That part of the device 10, after all, also becomes soiled during production.

As can be seen from FIGS. 1 and 6, in this example the cleaning device 60 is of movable design, in such a manner that the cleaning device 60 can be placed against that part of the production device 1 which is to be cleaned.

The cleaning device 60 comprises a housing 61, which can form a closed chamber around that part of the production device that is to be cleaned, in order for a cleaning process to be carried out in the said closed chamber.

In this example, the said housing 61—when it is bearing against a corresponding part of component 10 (cf. FIG. 7)—surrounds the fitting spindle 11 for the drum and the discharge belt 25 as well as the support spindle 18a. In this case, the underside of the housing 61 forms a collection trough 62 for cleaning liquid (that is to be recirculated). One or more sprayers or other similar devices which spray out optionally heated cleaning liquid may be provided in the cleaning device 60. The device 60 may likewise be provided with one or more filters, additions of chemicals, etc. It is preferable for the cleaning device also to be able to carry out a number of possible cleaning processes as desired. It is preferable for this cleaning device likewise to comprise inspection means (not shown) for inspecting the production device, so that the cleaning and the state of the device can be monitored.

For expedient production of three-dimensional food products by means of a system which uses exchangeable mould members, such as the mould drums which have been explained with reference to the drawing, it is preferable to provide for each removable mould member, in the examples mould drum 20, to be provided with an identification.

By way of example, each mould drum 20 is provided with an optically readable code (such as a barcode), an electronic transponder (which can be read and if appropriate written remotely), or other identification characteristic. The said characteristic is preferably unique to each mould member.

The system is in this case provided with suitable recognition or reading means for recognizing the identification of a mould member. If appropriate, it is also possible to provide writing means for adapting the identification characteristic, for example when using a writable transponder.

FIG. 1 indicates that the part 10 of the production device 1 is provided with recognition means for, preferably automatically, recognizing the identification of a mould drum 20, for example a reader 120 for a transponder which is arranged at a suitable location, for example at an head-end face, on the mould drum 20.

This reader 120 is connected to a control device 130 of the system, which in this case has an associated computer 131. A history of the use of the mould drum 20 is stored for each mould drum 20 in the memory of the computer 131. Partially on this basis, it is possible to determine the instant at which a mould drum 20 has to be cleaned, and if appropriate by what cleaning process. For example, the cleaning process can be matched to the type of mould drum, and the way in which each mould drum is cleaned can be determined separately.

The history can define the use of the mould drum 20, for example in conjunction with the identification provided to the products ultimately produced, which is useful, for example, in the context of product safety (for example if products need to be recalled).

In one variant, the cleaning device is (also) provided with recognition means for recognizing the identification of a mould member, such as reader provided in the distributor 51 in FIG. 5.

It is preferable, to provide storage for the history of a mould member, in which context the cleaning of the mould member is also stored. It is preferable for at least the times and the associated designation of the cleaning processes carried out to be stored.

The identification of mould members 20 allows optimum efficiency of the system to be achieved, in which context the correct cleaning of the mould members 20 can be ensured and documented. Furthermore, the cleaning of component 10 using cleaning device 60 can also be stored, so that a complete picture of the cleaning of the parts of the system which may become contaminated is obtained.

The use of, preferably automated, storage and conveyor means for the mould members allows their quality to be ensured and a high production rate to be achieved. Moreover, a change of mould members, for example when switching to a different shape of product, can be carried out quickly and with little operator intervention.

1.-15. (canceled)

16. A method for cleaning a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts,
wherein use is made of a cleaning device comprising a pump between a return line and a feed line, a collector connected to the return line, and
wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line,
the method comprising at least one chemical agent-based cleaning phase wherein a chemical composition is circulated, through the recirculation circuit and/or the mould member is sprayed with the chemical composition,
wherein the method comprises, following said at least one chemical agent-based cleaning phase, a rinsing phase wherein fresh water which is circulated, through the recirculation circuit, optionally also including spraying of the mould member with fresh water,
wherein in the rinsing phase a rinsing cycle is repeatedly performed, which rinsing cycle comprises:
a filling step wherein a volume of fresh water is filled into the recirculation circuit;
a recirculation step, wherein the volume of fresh water is recirculated, through the recirculation circuit, so that the water is forced though the internal fluid passage and the associated porous structure wall parts, thereby entraining fouling;
after completion of the recirculation step, a draining step, in which draining step the recirculated water with entrained fouling is drained from the recirculation circuit.

17. The method according to claim 16, wherein the rinsing cycle is repeated at least three times during the rinsing phase.

18. The method according to claim 16, wherein a first rinsing cycle of the rinsing phase is carried out with less recirculation of the water than later rinsing cycles.

19. The method according to claim 16, wherein between the chemical agent based cleaning phase and the rinsing phase a purging step is performed wherein pressurized air is forced through the internal fluid passages and the porous structure wall parts so as to purge the mould member from the liquid chemical composition.

20. The method according to claim 16, wherein the chemical agent-based cleaning phase is performed with heated water mixed with a chemical agent.

21. The method according to claim 16, wherein during one or more of the rinsing cycles the fresh water is heated fresh water.

22. The method according to claim 16, wherein the method comprises monitoring the water that is recirculated during the rinsing phase, and/or
wherein the presence of fouling is monitored.

23. The method according to claim 16, wherein the method comprises analyzing the water after the water has been drained.

24. The method according to claim 16, wherein the mould member is dried after the rinsing phase.

25. The method according to claim 16, wherein the method comprises two chemical agent-based cleaning phases,
wherein after each two-chemical agent-based cleaning phases a rinsing phase is affected, which rinsing phase comprises repeatedly performing a rinsing cycle, which rinsing cycle comprises:
a filling step wherein a volume of fresh water is filled into a recirculation circuit which includes the internal fluid passage and the associated porous structure wall parts of the mould member,
a recirculation step, wherein the volume of fresh water is recirculating through the recirculation circuit so that the water is forced though the internal fluid passage and the associated porous structure wall parts,
after completion of the recirculation step, a draining step, in which draining step the recirculated water is drained from the recirculation circuit.

26. The method according to claim 16, wherein the method comprises one or more initial rinsing phases prior to the at least one chemical agent-based cleaning phase, in which one or more initial rinsing phases fresh water is forced only once though the internal fluid passages and the porous structure wall parts, the water then being drained.

27. The method according to claim 26, wherein the method comprises a first initial rinsing phase wherein the water filled into the recirculation circuit in each filling step is at a low temperature and a second initial rinsing phase wherein the water filled into the recirculation circuit in each filling step is heated, said second initial rinsing phase being followed by one of more chemical agent based cleaning phases.

28. The method according to claim 16, wherein the mould member is a food products mould drum having an outer drum surface provided with the multiple recessed mould cavities, the mould drum further being provided with internal fluid passages that each extend between a respective feed opening and multiple porous structure wall parts.

29. The method according to claim 16, wherein the mould member has been fouled during production of food products from a meat mass.

30. In combination:
a food products mould member provided with multiple mould cavities, each with a mould cavity wall formed at least in part by a wall part with a porous structure, the mould member further being provided with an internal fluid passage which extends between a respective feed opening and one or more of the wall parts having porous structures;
which mould member has been become fouled in a process of moulding food products from a mass of one or more food starting materials involving filling the mass to the mould cavities and ejecting formed food products from the mould cavities of the mould member, said ejecting comprising the introduction of an ejection fluid via the feed opening into the internal passage, which ejection fluid passes through the associated porous structure wall parts;
a cleaning device comprising a pump between a return line and a feed line, a collector connected to the return line, and wherein a recirculation circuit is created by placing the mould member in the cleaning device and connecting the feed line to the feed opening, so that the recirculation circuit comprises the pump, feed line, internal fluid passage of the mould member, wall parts of the mould member having porous structures, mould cavities, the collector and the return line;
a control device programmed to carry out the cleaning process of claim 16.
